(19) United States
(12) Patent Application Publication
(10) Pub. No.: US 2023/0175738 A1
(43) Pub. Date: Jun. 8, 2023

(54) System for guiding the rotation of a solar tracker

(71) Applicant: NEXANS, Courbevoie (FR)

(72) Inventors: Emilie CHARTIER, AIX EN PROVENCE (FR); Jérémy AMAR, LES MILES (FR); Morgan PRINTEMPS, CIOTAT (FR); Ludovic QUEVILLIER, AUBAGNE (FR); Aymeric RICHARD, VENELLES (FR); Lucas GILLET, SAINT ZACHARIE (FR); Emile SOULIE, MEYRAGUES (FR)

(21) Appl. No.: 17/973,368

(22) Filed: Oct. 25, 2022

(30) Foreign Application Priority Data
Oct. 28, 2021 (FR) 2111493

(51) Int. Cl. F24S 30/425

(52) U.S. Cl. CPC F24S 30/425; F24S 2030/145

(57) ABSTRACT

A system for guiding the rotation of a solar tracker includes a system (1) for guiding the rotation of a solar tracker, having at least one arch (2) that can be mounted on the solar tracker and can rotate about an axis of rotation (100), and at least two guide devices (3) configured to guide the rotation of the arch (2).

### RELATED APPLICATION

This application claims the benefit of priority from French Patent Application No. 21 11493, filed on Oct. 28, 2021, the entirety of which is incorporated by reference.

### TECHNICAL FIELD

The present invention relates in general to guiding the rotation of solar trackers and more particularly to a system for guiding the rotation of a solar tracker and to a solar tracker having said rotation-guiding system.

### TECHNOLOGICAL BACKGROUND

EP2864719 describes a solar tracker which is mounted so as to be able to rotate on a frame and has a system for rotationally moving the solar tracker, said system having an arch which is mounted on the solar tracker and comprises a rack, and an endless screw engaging with the rack in order to produce the rotational movement. Such a solar tracker does not have a system for guiding the rotation of the solar tracker.

Guiding the rotation of the solar tracker enables a controlled and precise rotational movement of the solar tracker.

Document EP3501098 discloses another solar tracker structure having a movable device having a support structure in the form of a rigid lattice which extends longitudinally along the pivot axis of the movable device, and on which is fixed a plurality of solar panels in one and the same plane. In a preferred embodiment, the support structure in the form of a rigid lattice is fixed solely to the two arches which extend in a plane perpendicular to the pivot axis, such that the two arches constitute two sole supports for the support structure in the form of a rigid lattice. Each of the two arches moreover rests on a cradle for guiding the rotation of the corresponding arch, and each guide cradle is fixed in the upper part of a first ground support. The weight of the movable device is thus distributed over only two ground supports, via the two support arches. Such a structure makes it possible advantageously to obtain solar trackers of large size (typically a support structure in the form of a rigid lattice having a length of between 40 and 60 metres and a width of approximately 5 metres), with just two support arches which have a diameter of approximately 2 metres and are separated by a distance approximately equal to half of the length of the support structure, for example between 20 and 30 metres, and two ground supports. The guide cradles each have two guide devices each having, on the one hand, upper rollers and, on the other hand, lower rollers supporting the arch. The upper and lower rollers of each guide device form a rolling member and are configured to roll on a rolling strip borne by each arch. Each arch, on its radially outer edge, has lateral extensions on either side of the arch that are configured to be inserted between the upper and lower rollers of the support so as to make it possible to guide the rotation of the arch. Such guidance leads to phenomena of premature wear of the arches in the areas in which the lower rollers are in contact with the arches. This is because the entire weight of the movable device and of the arches is distributed over the lower rollers, thereby generating high contact pressures between the lower rollers and the arches.

### Objects and Summary

An aim of the present invention is to improve the systems for guiding the rotation of the solar trackers, notably that described in document EP3501098, notably with the aim of better distributing the forces exerted on the guide devices and their rollers.

To that end, according to a first aspect, a subject of the present invention is a system for guiding the rotation of a solar tracker, having:
at least one arch that can be mounted on the solar tracker and can rotate about an axis of rotation,
at least two guide devices configured to guide the rotation of the arch, the guide devices each having at least two rollers, each of which is rotatable about an axis of rotation extending in the direction of the axis of rotation of the arch and which are configured to come into contact with and support the arch, the guide devices each being rotatable about an axis of rotation extending in the direction of the axis of rotation of the arch, and each being able to be driven in rotation by the arch so as to enable each roller of each guide device to make contact with the arch.

In order to stay in static equilibrium, each guide device can be rotated about its axis of rotation by the forces exerted by the arch on the guide devices. Such guide devices may thus be referred to as hypostatic structures.

The use of guide devices which themselves can rotate about their axis of rotation makes it possible to better distribute the forces over the guide devices, notably over the rollers of the guide devices. In other words, owing to the fact that the rotation of each guide device about its axis of rotation is permitted, the positioning of the guide device, and notably of the rollers in contact with the arch, is optimized, thereby making it possible for the pressure of the arch to be substantially evenly distributed over each of the guide devices, in particular over each of the rollers of the guide devices. This can make it possible to limit the contact pressure of the arch on the rollers, and therefore to limit the wear to the arch resulting from contact between the arch and the rollers.

Additionally, such guide devices which themselves can rotate about their axis of rotation can be adapted easily to various arches having different diameters or curvatures.

The fact that the guide devices can each rotate about an axis of rotation extending in the direction of the axis of rotation of the arch makes it possible to keep the rollers of each guide device in contact with the arch.

The rotation of each guide device about its axis of rotation makes it possible specifically to ensure that each roller of the guide devices is in contact with the arch. A hyperstatic guide device, i.e. one which cannot rotate, would not make it possible for the arch to be supported on each of the rollers of the guide devices.

Arch

The axis of rotation of the arch is preferably identical to that of the solar tracker.

The arch preferably extends in a plane perpendicular to its axis of rotation.

The arch may have a curved profile, preferably in the shape of a semicircle. The diameter of the arch may be between 1.8 and 2.5 metres, and notably be equal to approximately 2.2 metres.

The arch may be mountable on the solar tracker at least via its ends.

Rolling Strip

The arch may have a rolling strip and the roller(s) of each guide device may be configured to come into contact with the rolling strip of the arch. As already mentioned above, the system according to the invention can make it possible to limit the wear to the rolling strip of the arch resulting from contact between the rollers and the rolling strip of the arch.

The rotation of each guide device about its axis of rotation can make it possible to keep the roller(s) of each guide device in contact with the rolling strip of the arch.

The rolling strip is preferably located on a radially outer edge of the arch.

Roller

The rollers are preferably cylindrical.

The rollers may have an elongate shape along their axis of rotation. They may have a width substantially equal to that of the rolling strip of the arch, for example a width of between 80 and 110 mm. An elongate shape makes it possible to increase the contact surface area between the roller and the arch and therefore to reduce the contact pressure of the arch on the roller.

The rollers may have for example an inside diameter of between 18 and 30 mm and an outside diameter of between 50 and 100 mm.

The rollers may have a rolling surface configured to come into contact with the rolling strip of the arch.

The rollers may be made entirely from a composite material and/or a polymer-based material, for example a plastics-based material, including their rolling surfaces.

The rollers are preferably mounted so as to be able to freely rotate about their axis of rotation.

The axes of rotation of the rollers of each guide device are preferably strictly parallel.

The distance between the axes of rotation of the rollers of each guide device may be between 150 and 200 mm.

Guide Device

The guide devices are disposed in series along the arch.

The guide devices are preferably aligned with respect to one another along the axis of an axis comprised within the plane in which the arch extends.

The distance between the axes of rotation of the guide devices may be between 800 and 1000 mm.

The guide devices are preferably each mounted so as to be able to freely rotate about their axis of rotation.

The guide devices may be mounted, preferably at the level of their axis of rotation, on one and the same support structure extending in a direction perpendicular to the direction of the axis of rotation of the arch. This can make it possible to align the guide devices with respect to one another so as to make it possible to guide the rotation of the arch.

The support structure is for example a bar or a tube, preferably rectilinear and/or with a circular cross section.

The length of the support structure may be between 1000 and 1300 mm.

The support structure may be able to be mounted on an upper part of a ground-support structure.

The ground-support structure may have one or more driven, bored or screwed piles, notably two driven, bored or screwed piles, or a concrete block. In a variant, it has an intermediate frame which rests on one or more driven piles, notably on two driven piles, or on a concrete block.

The support structure is preferably rigid enough to support the forces of the solar tracker.

Advantageously, the support structure can rotate about its axis of extent which is perpendicular to the direction of the axis of rotation of the arch. The rotation of the support structure about its axis of extent can make it possible to compensate the static unevennesses of the ground, and notably make it possible to install the solar tracker on a slope. This can thus enable precise angular orientation of the solar tracker about an axis of rotation extending in a direction perpendicular to the axis of rotation of the arch.

The support structure may be mounted so as to be able to freely rotate about its axis of extent.

For example, the support structure is fixed at each of its ends to the ground-support structure via a clamping collar.

Advantageously, the clamping of the collar is such that it allows the support structure to freely rotate about its axis of extent.

Lateral Stop

The guide devices may each have at least two lateral stops located on either side of the arch and the arch may have lateral extensions on either side of the arch that are disposed between the lateral stops and the rollers of the guide devices.

The lateral extensions of the arch are thus sandwiched between the lateral stops and the rollers of the guide devices. The presence of the lateral stops may make it possible to avoid a situation in which the arch rises, for example caused by the force of the wind, since in that case the lateral extensions of the arch come to bear against the lateral stops of the guide devices.

When the arch rotates about its axis of rotation, the lateral extensions of the arch can slide against the lateral stops of the guide devices.

The lateral stops are preferably made from a composite material and/or a polymer-based material, for example a plastics-based material.

The lateral stops are preferably located facing the flanks of the arch.

The lateral extensions preferably extend over at least more than half, notably over at least more than three quarters, or even over substantially the entire length of the arch.

The lateral extensions may have a small thickness, for example between 3 and 5 mm, or even a larger thickness, for example between 5 and 8 mm.

The lateral extensions may be inserted into the continuation of the radially outer edge of the arch or at the level of the flanks of the arch.

The lateral stops of each guide device may each have at least one axial-guidance wheel which can rotate about an axis of rotation extending in a direction perpendicular to the direction of the axis of rotation of the arch and which is configured to come into contact with the flanks of the arch. The presence of axial-guidance wheels can make it possible to axially guide the arch so as to keep it centred between the two lateral stops of each guide device. In addition, these axial-guidance wheels can make it possible to react the axial forces of the solar tracker, notably when the solar tracker is installed on a slope.

The axial-guidance wheels of the lateral stops are preferably mounted so as to be able to freely rotate.

The guide devices may each be movable in translation along their axis of rotation. This can make it possible to compensate for the thermal expansion of the solar tracker which can take place between winter and summer, for example. This translational movement of the guide device therefore makes it possible to limit the forces associated with the thermal expansion of the solar tracker.

The guide devices can each be movable in translation in the two directions with respect to the axis of extent of the support structure. The translational movement of each of the guide devices is preferably guided along their axis of rotation.

The guide devices may each have, about their axis of rotation, a pair of plain bearings, notably flanged plain bearings. The use of plain bearings can facilitate the translational movement and the rotation of the guide devices.

The plain bearings are preferably made from a composite material and/or a polymer-based material, notably from a plastics-based material. For example, the plain bearings may be entirely polymer-based or be made of a metallic material, notably bronze, which is coated with a polymer-based layer. This can make it possible to avoid the use of grease while still ensuring high mechanical stability and a limited coefficient of friction.

The magnitude of the translational movement of each of the guide devices along their axis of rotation may be between 10 and 70 mm, preferably between 20 and 60 mm.

Another subject of the present invention is a solar tracker having:
at least one rotation-guiding system as defined above,
at least one table equipped with at least one solar energy collecting device, the table extending longitudinally in the direction of the axis of rotation of the arch,
at least one underpinning structure, notably a lattice beam, extending longitudinally in the direction of the axis of rotation of the arch and supporting, notably by itself, said table, the arch being mounted on the underpinning structure so as to drive the rotation of the underpinning structure about the axis of rotation of the arch.

In a preferred embodiment, the solar tracker has at least two rotation-guiding systems as defined above and each arch is mounted on the underpinning structure so as to drive the rotation of the underpinning structure about the axis of rotation of the arches.

The table is preferably equipped with a plurality of solar panels in one and the same plane.

The underpinning structure is preferably rigid enough to support the table.

The arch(es) may be configured to support the underpinning structure. In other words, the arch(es) constitute the sole support(s) for the underpinning structure.

The solar tracker may moreover have a drive system configured to drive the rotation of the arch about its axis of rotation.

When the solar tracker has at least two rotation-guiding systems, the arches preferably have identical axes of rotation and are preferably located in parallel planes.

Another subject of the present invention is a solar farm having a plurality of solar trackers as defined above.

At least some solar trackers may be disposed parallel to one another, notably in the North/South direction.

### BRIEF DESCRIPTION OF THE DRAWINGS

The invention will be able to be better understood from reading the following detailed description of a non-limiting example of implementation thereof, and from examining the appended drawing, in which:

FIG. 1 schematically shows an example of a system for guiding the rotation of a solar tracker according to the invention,

FIG. 2 schematically shows a perspective and partial view of an example of a system for guiding the rotation of a solar tracker according to the invention,

FIG. 3 schematically shows a perspective and partial view of an example of a system for guiding the rotation of a solar tracker according to the invention,

FIG. 4a shows a cross section through an arch interacting with a guide device,

FIG. 4b shows a variant of the arch interacting with the guide device shown in FIG. 4a,

FIG. 4c shows another variant of the arch interacting with the guide device shown in FIG. 4a,

FIG. 5 schematically shows a perspective view of a detail of the system for guiding the rotation of a solar tracker according to the invention,

FIG. 6 schematically shows a perspective view of another detail of the system for guiding the rotation of a solar tracker according to the invention,

FIG. 7 schematically shows a perspective view of a detail of the guide system shown in FIG. 6,

FIG. 8 schematically shows a perspective and partial view of an example of a solar tracker according to the invention.

### DETAILED DESCRIPTION

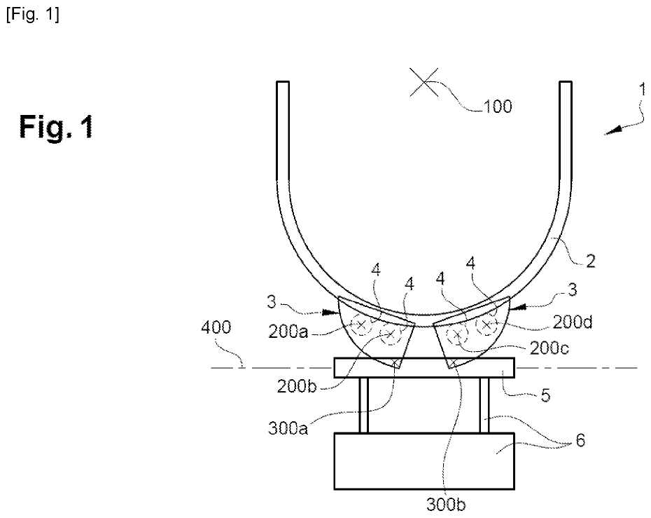

The rotation-guiding system 1 shown in FIG. 1 has an arch 2 that can be mounted on a solar tracker (not shown) and can rotate about an axis of rotation 100, and two guide devices 3 configured to guide the rotation of the arch 2 about its axis of rotation 100. Thus, the arch 2 is configured to interact with two guide devices 3.

The guide devices 3 each have at least two rollers 4, each of which can rotate about an axis of rotation 200a, 200b, 200c, 200d extending in the direction of the axis of rotation 100 of the arch 2 and which are configured to come into contact with and support the arch 2.

The rollers 4 are preferably mounted so as to be able to freely rotate.

The guide devices 3 can each rotate about an axis of rotation 300a, 300b extending in the direction of the axis of rotation 100 of the arch 2. Thus, each guide device 3 can be driven in rotation about its axis of rotation 300a, 300b by the arch 2 so as to enable each roller 4 of each guide device 3 to be in contact with the arch 2.

The guide devices 3 are preferably mounted so as to be able to freely rotate.

The guide devices 3 are mounted on one and the same support structure 5 extending in a direction perpendicular to the direction of the axis of rotation 100 of the arch 2.

The support structure 5 is therefore configured to support the guide devices 3 and the arch 2.

The support structure 5 may be mounted on an upper part of a ground-support structure 6.

The arch 2 preferably can be mounted, at least at each of its ends, on the framework of the solar tracker. It may thus constitute a sole support for the solar tracker.

The arch preferably forms an arc of a circle, notably a semicircle, the centre of which is on the axis of rotation 100 of the arch 2.

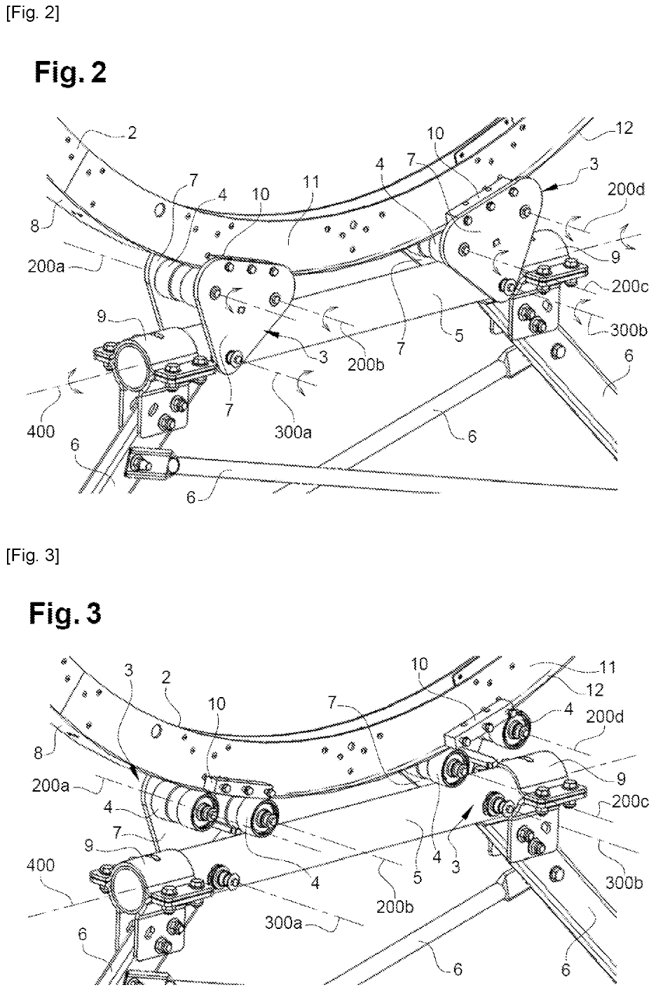

With reference to FIGS. 2 and 3, a more detailed description will now be given of the guide devices 3 of the rotation-guiding system 1 according to the invention.

Each guide device 3 has two mounting plates 7, preferably mutually parallel, located on either side of the arch 2, between which the rollers 4 are mounted so as to be able to rotate about their respective axes of rotation 200a, 200b, 200c and 200d.

The rollers 4 are located at the level of the upper part of the guide devices 3.

The rollers 4 are configured to come into contact with a rolling strip 8 of the arch 2, which is located on a radially outer edge of the arch 2 and so as to support the arch 2. Thus, the rollers 4 can be driven in rotation about their respective axes of rotation 200a, 200b, 200c and 200d by the rotation of the arch 2 about its axis of rotation 100.

The support structure 5 on which the guide devices 3 rest is located at the level of the lower part of the guide devices 3. The support structure 5 is thus inserted between the two mounting plates 7 of each guide device 3.

In the example illustrated in FIG. 2, the mounting plates 7 of the guide devices 3 are triangular, with an apex pointing towards the ground, at the level of which the support structure 5 is located, and a side opposite to said apex which points towards the arch 2, at the level of which the rollers 4 are located.

Through-orifices made in the support structure 5 make it possible to mount the guide devices 3 so as to be able to rotate about their respective axes of rotation 300a, 300b.

The forces exerted by the arch 2 on the guide devices 3 make it possible to drive the rotation of the latter about their respective axes of rotation 300a, 300b such that the rollers 4 of each guide device 3 each come into contact with the rolling strip 8 of the arch 2.

As can be seen in FIGS. 2 and 3, the support structure 5 is mounted on the upper part of the ground-support structure 6, which in this example is an intermediate frame resting either on driven piles, or on a concrete block (not shown). In a variant which is not shown, the support structure 5 rests directly on driven piles or a concrete block.

The support structure 5 may be a rectilinear bar or tube, for example with a circular cross section. It is preferably rigid enough to support the guide devices 3 and the arch 2.

The support structure 5 is fixed at each of its ends to the ground-support structure 6 via clamping collars 9.

Advantageously, at the time the support structure 5 is being mounted on the ground-support structure 6, the clamping of the collars 9 is such that it makes it possible for the support structure 5 to rotate, preferably to freely rotate, about its axis of extent 400, which is perpendicular to the direction of the axis of rotation 100 of the arch 2.

The rotation of the support structure 5 about its axis of extent 400 makes it possible to compensate the static unevennesses of the ground, and notably makes it possible to install the solar tracker on a slope. The ground-support structure 6 can then extend vertically and the axis of rotation 100 of the arch 2 can extend parallel to the slope.

Once the support structure 5 has pivoted about its axis of extent 400 to compensate the static unevennesses of the ground, for example such that the axis of rotation 100 of the arch 2 extends parallel to the slope, the collars 9 are clamped so as to prevent the rotation of the support structure 5 about its axis of extent 400.

As illustrated in FIGS. 2 and 3, the guide devices 3 moreover each have at least two lateral stops 10 located on either side of the arch 2. The lateral stops 10 are each fixed on a mounting plate 7 of the guide devices 3 and are located between the two plates 7, facing the flanks 11 of the arch 2.

The arch 2 has lateral extensions 12 on either side of the arch 2 that are disposed between the lateral stops 10 and the rollers 4 of the guide devices 3.

The use of lateral stops 10 makes it possible to avoid a situation in which the arch 2 rises, for example caused by the force of the wind, since in that case the lateral extensions 12 of the arch 2 come to bear against the lateral stops 10 of the guide devices 3.

FIG. 3 shows the system 1 of FIG. 2 with one of the mounting plates 7 of each guide device 3 removed so as to be able to better see the rollers 4 and the lateral stops of the guide devices 3.

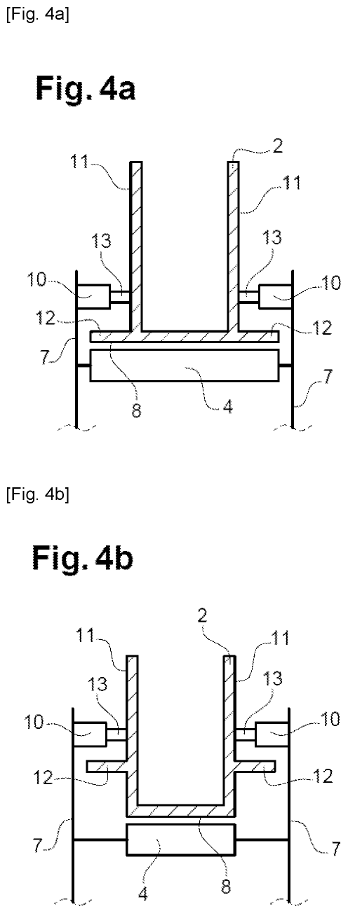

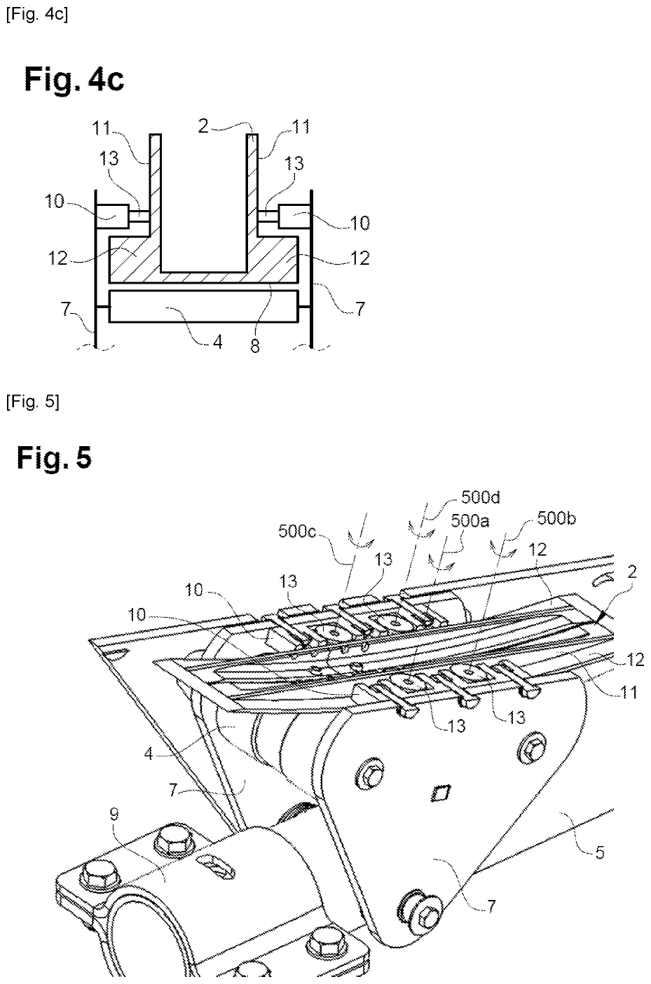

As illustrated in FIGS. 4a to 4c, the arch 2 has a profile with a cross section in the shape of a “U”. The large sides of the “U” form the flanks 11 of the arch 2 and are connected to one another by the small side forming the radially outer edge which bears the rolling strip 8 of the arch 2.

The lateral extensions 12 of the arch 2 may be inserted in the continuation of the radially outer edge of the arch 2, as illustrated in FIG. 4a, or on the flanks 11 of the arch 2, as illustrated in FIG. 4b.

The lateral extensions 12 of the arch 2 have a thickness approximately equal to that of the walls of the “U”-shaped profile of the arch 2, as illustrated in FIGS. 4a and 4b. For example, the thickness of the lateral extensions is between 3 and 5 mm. In a variant, the lateral extensions 12 have a thickness greater than that of the walls of the “U”-shaped profile of the arch 2, as illustrated in FIG. 4c. For example, the thickness of the lateral extensions is between 5 and 20 mm.

The lateral stops 10 are immobilized on the mounting plates 7 via fixing means, such as riveted or screwed connections.

As illustrated in FIGS. 4a to 4c and FIG. 5, the lateral stops 10 of each guide device 3 have two axial-guidance wheels 13, each of which can rotate about an axis of rotation 500a, 500b, 500c, 500d extending in a direction perpendicular to the direction of the axis of rotation 100 of the arch 2 and which are configured to come into contact with the flanks 11 of the arch 2.

The axial-guidance wheels 13 are received in housings made in the lateral stops 10.

The axial-guidance wheels 13 make it possible to axially guide the arch 2, notably so as to keep it centred between the two lateral stops 10 of each guide device 3 and to react the axial forces of the solar tracker, in particular when the latter is installed on a slope.

The axial-guidance wheels 13 are preferably mounted so as to be able to freely rotate.

In addition to being able to rotate about their respective axes 300a, 300b, the guide devices 3 can each move in translation along their respective axes 300a, 300b. This advantageously makes it possible to compensate for the thermal expansion of the solar tracker which can take place between winter and summer, for example, and therefore to limit the forces associated with the thermal expansion of the solar tracker.

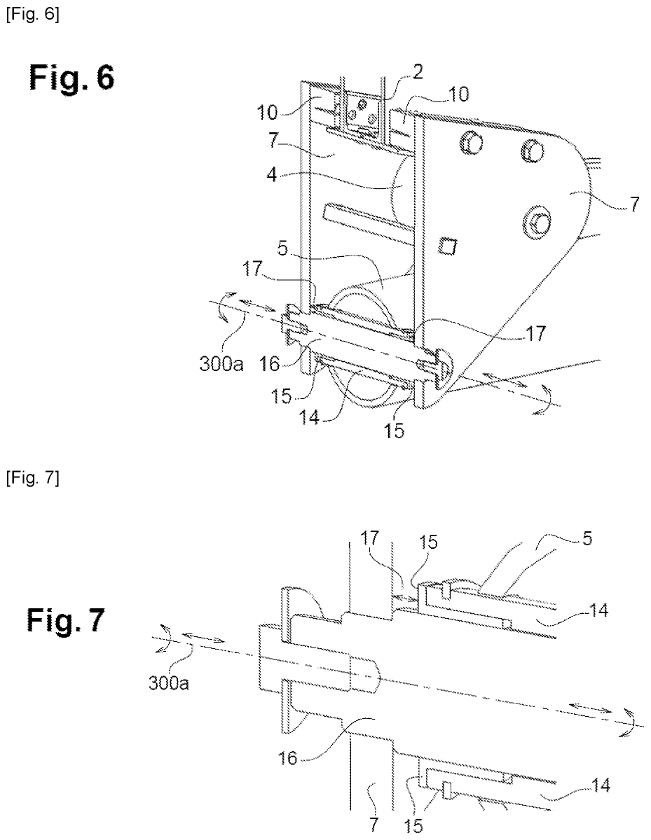

As illustrated in FIGS. 6 and 7, the guide devices 3 each have a rod 16 extending along the axis of rotation 300a, 300b of the guide device 3 and making it possible to mount the guide device 3 on the support structure 5.

The rod 16 connects the two mounting plates 7 and is inserted in the through-orifice made in the support structure 5.

The rod 16 is surrounded by a rolling member 14 which is preferably metallic, for example made of steel or stainless steel, and which has, at each of its ends, a flanged plain bearing 15, preferably made of a composite material and/or a polymer-based material, for example a plastics-based material. This rolling member 14 enables the movement in translation along the axis 300a and the rotational movement of the guide device about the axis 300a.

The guide devices 3 are each initially mounted on the support structure 5 so as to be centred with respect to the support structure 5 with a clearance 17, of approximately 10 mm, on each side between the flange of the plain bearing and the inner face of the mounting plate 7 of the guide device 3.

This clearance 17 of approximately 10 mm on each side enables translational movements of the guide device 3 along the axis 300a with a magnitude of 20 mm. In a variant, this clearance 17 may be 20 mm or even 30 mm on each side, so as to enable a translational movement with a magnitude of 40 mm or even 60 mm, respectively.

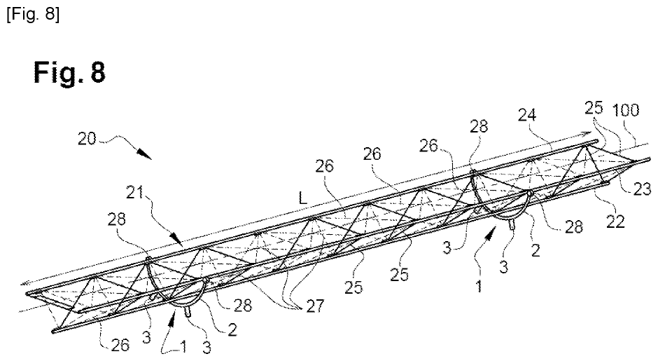

FIG. 8 illustrates an example of a solar tracker 20 having:
two rotation-guiding systems 1 according to the invention,
an underpinning structure 21 extending longitudinally in the direction of the axis of rotation 100 of the arches 2 and supporting, notably by itself, a table (not shown) which is equipped with at least one solar energy collecting device and extends longitudinally in the direction of the axis of rotation 100 of the arch 2.

The underpinning structure 21 is a rigid-lattice beam having longitudinal members 22, 23, 24, crossmembers 25 and tie rods 26.

In the example illustrated in FIG. 8, the underpinning structure has three longitudinal members 22, 23, 24 which extend parallel to one another in the direction of the axis of rotation 100 of the arches 2, and a large number of crossmembers 25 distributed along the axis of rotation 100 of the arch 2 so as to mechanically connect each of the three longitudinal members in pairs. The crossmembers 25 are disposed in relation to the three longitudinal members 22, 23, 24 so as to form a plurality of triangles 27 which are parallel to one another and are each present in a plane perpendicular to the direction of the axis of rotation 100 of the arches 2.

Each arch 2 is mounted on the underpinning structure 21 so as to drive the rotation of the underpinning structure 21 about the axis of rotation 100 of the arches 2.

Each arch 2 is mounted on the underpinning structure 21 of the solar tracker 20 at least at each of its ends 28. The arches 2 thus support the underpinning structure 21 of the solar tracker 20 by themselves.

1. A system for guiding the rotation of a solar tracker, comprising:
at least one arch that can be mounted on the solar tracker and can rotate about an axis of rotation,
at least two guide devices configured to guide the rotation of the arch, the guide devices each having at least two rollers, each of which is rotatable about an axis of rotation extending in the direction of the axis of rotation of the arch and which are configured to come into contact with and support the arch, the guide devices each being rotatable about an axis of rotation extending in the direction of the axis of rotation of the arch, and each being able to be driven in rotation by the arch so as to enable each roller of each guide device to make contact with the arch.

2. The system according to claim 1, wherein the axes of rotation of the rollers are strictly parallel.

3. The system according to claim 1, wherein the guide devices are fixed on one and the same support structure extending in a direction perpendicular to the direction of the axis of rotation of the arch.

4. The system according to claim 1, wherein the guide devices each have at least two lateral stops located on either side of the arch and wherein the arch has lateral extensions on either side of the arch that are disposed between the lateral stops and the rollers of the guide devices.

5. The system according to claim 4, wherein the lateral stops of each guide device each have at least one axial-guidance wheel which can rotate about an axis of rotation extending in a direction perpendicular to the direction of the axis of rotation of the arch and which is configured to come into contact with the flanks of the arch.

6. The system according to claim 1, wherein the guide devices are each movable in translation along their axis of rotation.

7. A solar tracker having:
at least one rotation-guiding system according to claim 1,
at least one table equipped with at least one solar energy collecting device, the table extending longitudinally in the direction of the axis of rotation of the arch,
at least one underpinning structure that is a lattice beam, extending longitudinally in the direction of the axis of rotation of the arch and supporting, by itself, said table,
the arch being mounted on the underpinning structure so as to drive the rotation of the underpinning structure about the axis of rotation of the arch.

8. The solar tracker according to claim 7, having at least two rotation-guiding systems according to claim 1, wherein each arch is mounted on the underpinning structure so as to drive the rotation of the underpinning structure about the axis of rotation of the arches.

9. A solar farm having a plurality of solar trackers according to claim 7.

10. The solar farm according to claim 9, wherein at least some solar trackers are disposed parallel to one another.

11. The system according to claim 3, wherein the support structure is a tube or a bar

12. The solar tracker as claimed in claim 7, wherein said at least one underpinning structure is a lattice beam.

13. The solar arm according to claim 10, wherein at least some solar trackers are disposed parallel to one another in the North/South direction.
